(19) United States
(12) Patent Application Publication
(10) Pub. No.: US 2025/0043811 A1
(43) Pub. Date: Feb. 6, 2025

(54) BLIND FASTENER

(71) Applicant: Howmet Aerospace Inc., Pittsburgh, PA (US)

(72) Inventor: Luke L. Haylock, Culver City, CA (US)

(73) Assignee: Howmet Aerospace Inc., Pittsburgh, PA (US)

(21) Appl. No.: 18/926,919

(22) Filed: Oct. 25, 2024

Related U.S. Application Data
(63) Continuation of application No. PCT/US2022/049710, filed on Nov. 11, 2022.
(60) Provisional application No. 63/352,780, filed on Jun. 16, 2022.

(51) Int. Cl. F16B 19/10

(52) U.S. Cl. CPC F16B 19/1072; F16B 2200/93

(57) ABSTRACT

A fastener includes a sleeve, a core bolt and an insert. The sleeve includes a tubular portion and an internal thread. The core bolt includes a cylindrical portion, a threaded portion with an external thread, and a thread runout between the cylindrical portion and the threaded portion. The core bolt is disposed within the sleeve and the external thread engages the internal thread. The insert is disposed within the sleeve and encircles a portion of the core bolt. The insert abuts and is retained between the internal thread and the thread runout in a pre-installation position. The insert is compressed between the internal thread and the thread runout by an installation motion of the core bolt simultaneously with a generation of a compressive load on the sleeve. The insert deforms simultaneously with and facilitates a formation of a bulb in the sleeve in response to the compression.

### CROSS-REFERENCE TO RELATED APPLICATION

This application is a U.S. Continuation Application of PCT Application No. PCT/US2022/049710, filed Nov. 11, 2022, which relates to and claims the benefit of commonly-owned, co-pending U.S. Provisional Patent Application Ser. No. 63/352,780, filed Jun. 16, 2022, entitled “BLIND FASTENER,” the contents of which are incorporated herein by reference in its entirety.

### FIELD

The present invention relates to fasteners and, more particularly, to blind fasteners for securing carbon fiber reinforced composite workpieces together which are exposed to lightning strikes.

### BACKGROUND

Blind fasteners are commonly used to secure a plurality of workpieces together when only limited physical or visible access is available on one side of the workpieces. There is a trend toward using carbon fiber reinforced composites for aircraft structures, as these materials have a good strength-to-weight ratio, stiffness, and resistance to fatigue induced damage. There is also a trend toward natural laminar and hybrid laminar flow wing designs for greater fuel efficiency. Such wings generally have thinner cross sections with limited access inside the wing.

Aircraft are commonly struck by lightning. This is especially critical for carbon fiber reinforced composites structures with inherent lower electrical conductivity and because metallic fasteners are often the primary pathway of the lightning currents which are not fully distributed over the skin of composite aircraft. In such situations, lightning currents may create detrimental ignition sources by arcing between fasteners and the composite structure. Although the main danger from the lightning strikes is the fastener arcing which creates a potential ignition source for fuel vapor, the Joule heating of materials, plasma activity and material vaporization along the fastener/structure assemblies lead to substantial physical damage to the fasteners and the surrounding structure.

Carbon fiber reinforced composites are typically composed of a combination of a binding polymer, commonly referred to as the matrix, and high strength carbon fibers. The orientation of the carbon fibers, the matrix-to-fiber ratio, and composition of both the fibers and the matrix can be tailored to achieve specific target properties for specific applications. The mechanical, electrical, and environmental properties of carbon fiber reinforced composites can also be affected by various types of additives which can be introduced to the binding matrix.

A wide range of fabrication techniques have been developed but many employ some sort of layered fabrication process which involves combining fibers into unidirectional or woven fabric layers which are then stacked onto each other in a quasi-isotropic layup, e.g., 0°, +60°, or −60°, relative to each other. In some cases, the matrix is combined with individual layers. In other cases the matrix is infused into the stack after the individual layers have been stacked. Fabrication techniques continue to evolve to reduce cost, but two-dimensional stacked layers are much more common than three-dimensional stacks. Variations on two-dimensional stacked techniques are commonly used to fabricate aircraft structural sections, such as fuselage and wings. While some techniques enable large scale integration of features, there is a need to mechanically join sub-sections with fasteners to form assemblies. This is especially true where subsections are built with dissimilar materials.

One of the challenges is that sub-sections or individual parts have inherent isotropic mechanical and electrical properties which are products of the stacked layered nature of their construction. Thus, the development of composite aircraft has led to a greater demand for mechanical fasteners, which are electrically compatible to composite structures by being significantly less conductive than those used in metallic aircraft; and, thus, more susceptible to lightning damage. Anisotropic resistive properties and elevated contact resistances directly affect current paths and resulting electric fields within electrically connected regions in aircraft sections joined by fasteners. These electrical irregularities also directly affect the aircraft's electromagnetic response to high-frequency waves.

The trends toward greater use of carbon fiber reinforced composites and natural laminar and hybrid laminar flow wings create a need for blind fasteners with low inherent contact resistance between the components of the fastener assembly itself, as well as low contact resistance between the fastener and the surrounding composite structure. Such fasteners would enable lightning currents to be transferred from one structural element to another and through the surrounding structure with relatively few adverse effects. As the currents and electric fields within the aircraft structure evolve, low electrical continuity between fastener surfaces and internal joints due to interface resistivities will be critical in influencing the distribution of current flows.

### SUMMARY

In some embodiments, a fastener includes a sleeve including a first end and a second end opposite the first end; a tubular portion including an external surface, an internal surface, and an internal thread formed within the internal surface at the second end; and a core bolt including a first end and a second end opposite the first end of the core bolt, an external surface, a cylindrical portion proximate to the first end of the core bolt, an external threaded portion proximate to the second end of the core bolt, and a thread runout between the cylindrical portion and the external threaded portion, wherein the core bolt is configured to be disposed within the sleeve, and wherein the external threaded portion is configured to threadedly engage the internal thread of the sleeve; and an insert configured to be disposed within the sleeve and encircle a portion of the core bolt proximate to the second end thereof, wherein the insert is sized and shaped to abut and be retained between the internal thread of the sleeve and the thread runout of the core bolt when the fastener is in a pre-installation position, wherein the insert is configured to be compressed between the internal thread of the sleeve and the thread runout of the core bolt by an installation motion of the core bolt with respect to the sleeve with a generation of a compressive load on the sleeve by the installation motion of the core bolt, wherein the insert is configured to deform and facilitate a formation of a bulb in the sleeve in response to compression of the insert, wherein the insert is configured to fill a void at an area between the external surface of the core bolt proximate to the second end thereof and the sleeve proximate to the second end of the tubular portion of the sleeve, and wherein the insert is configured to provide an electrically conductive path between the sleeve and the core bolt at the area.

In some embodiments, the sleeve is composed of steel. In some embodiments, a first friction coefficient between the internal surface of the sleeve and the external surface of the core bolt and a second friction coefficient between the internal surface of the sleeve and the external surface of the insert are selected to facilitate sliding contact between the sleeve and the core bolt and between the sleeve and the insert during installation of the fastener. In some embodiments, the sleeve includes a first layer on the external surface of the sleeve, wherein the first layer includes a first hardness, and a second layer on the internal surface of the sleeve, wherein the second layer includes a second hardness, and wherein the second hardness is greater than the first hardness.

In some embodiments, the first layer is a coating. In some embodiments, the coating is composed of a metal-based coating. In some embodiments, the coating is selected from the group consisting of silver, gold, nickel, cadmium, copper, and lead, or alloys thereof. In some embodiments, the coating is composed of bronze. In some embodiments, the sleeve includes a third layer over the second layer. In some embodiments, the second layer is composed of carbon and the third layer is composed of nitrogen and carbon. In some embodiments, the insert is composed of copper. In some embodiments, the insert is composed of a Monel alloy.

In some embodiments, the insert includes a coating. In some embodiments, the coating is selected from the group consisting of silver, gold and nickel. In some embodiments, the sleeve includes a band annealed portion proximate to the insert. In some embodiments, the core bolt includes a head at the first end thereof, wherein the sleeve includes a head at the first end thereof, and wherein the head of the sleeve includes a pocket sized and shaped to receive the head of the core bolt. In some embodiments, the head of the sleeve is configured to be installed in an accessible hole in a plurality of workpieces, and wherein the bulb is configured to be located on a blind side of the workpieces.

In some embodiments, a fastener includes a sleeve including a first end and a second end opposite the first end, an internal surface, a tubular portion having, a head located at the first end, a first portion proximate to the first end and having a first inner diameter, a second portion adjacent the first portion and having a second inner diameter that is less than the first inner diameter of the first portion, a third portion proximate to the second end and having an internal thread in the internal surface, and a step located between the first portion and the second portion; a core bolt including a first end and a second end opposite the first end of the core bolt, an external surface, a cylindrical portion proximate to the first end of the core bolt, an external threaded portion proximate to the second end of the core bolt, and a thread runout between the cylindrical portion and the external threaded portion, wherein the core bolt is configured to be disposed within the sleeve, and wherein the external threaded portion is configured to threadedly engage the internal thread of the sleeve; and an insert configured to be disposed within the sleeve and encircle a portion of the core bolt proximate to the second end thereof, wherein the insert is sized and shaped to abut and be retained between the step of the sleeve and the thread runout of the core bolt when the fastener is in a pre-installation position, wherein the insert is configured to be compressed between the internal thread of the sleeve and the thread runout of the core bolt by an installation motion of the core bolt with respect to the sleeve with a generation of a compressive load on the sleeve by the installation motion of the core bolt, and wherein the insert is configured to deform and facilitate a formation of a bulb in the sleeve in response to compression of the insert, wherein the insert is configured to fill a void at an area between the external surface of the core bolt proximate to the second end thereof and the internal surface of the sleeve proximate to the second end of the tubular portion of the sleeve, and wherein the insert is configured to provide an electrically conductive path between the sleeve and the core bolt at the area.

In some embodiments, a first friction coefficient between the internal surface of the sleeve and the external surface of the core bolt and a second friction coefficient between the internal surface of the sleeve and the external surface of the insert are selected to facilitate sliding contact between the sleeve and the core bolt and between the sleeve and the insert during installation of the fastener. In some embodiments, the sleeve includes a first layer on the external surface of the sleeve, wherein the first layer includes a first hardness, and a second layer on the internal surface of the sleeve, wherein the second layer includes a second hardness, and wherein the second hardness is greater than the first hardness.

### BRIEF DESCRIPTION OF THE DRAWINGS

FIGS. 1 and 2 are perspective and side elevational views, respectively, of some embodiments of a core bolt employed by a fastener of the present invention;

FIGS. 3 through 7 are perspective, side elevational, and cross-sectional perspective and side elevational views of some embodiments of a sleeve employed by the fastener;

FIG. 8 is a perspective view of some embodiments of an insert employed by the fastener;

FIGS. 9 through 15 are various perspective, side elevational, and cross-sectional perspective and side elevational views of some embodiments of a fastener employing the core bolt, the sleeve and the insert shown in FIGS. 1 through 8;

FIGS. 16 and 17 are side elevational and cross-sectional side elevational views of some embodiments of the fastener shown in FIGS. 9 through 15, the fastener being pre-installed in a plurality of workpieces; and

FIGS. 18 and 19 are side elevational and cross-sectional side elevational views of some embodiments of the fastener shown in FIGS. 16 through 17, the fastener being fully installed in the plurality of workpieces.

### DETAILED DESCRIPTION

As shown, for example, in FIG. 10, in some embodiments, a fastener 10 includes a core bolt 12, a sleeve 14 and an insert 16. In some embodiments, the sleeve 14 is sized and shaped to receive the core bolt 12 and the insert 16, which will be described in further detail below.

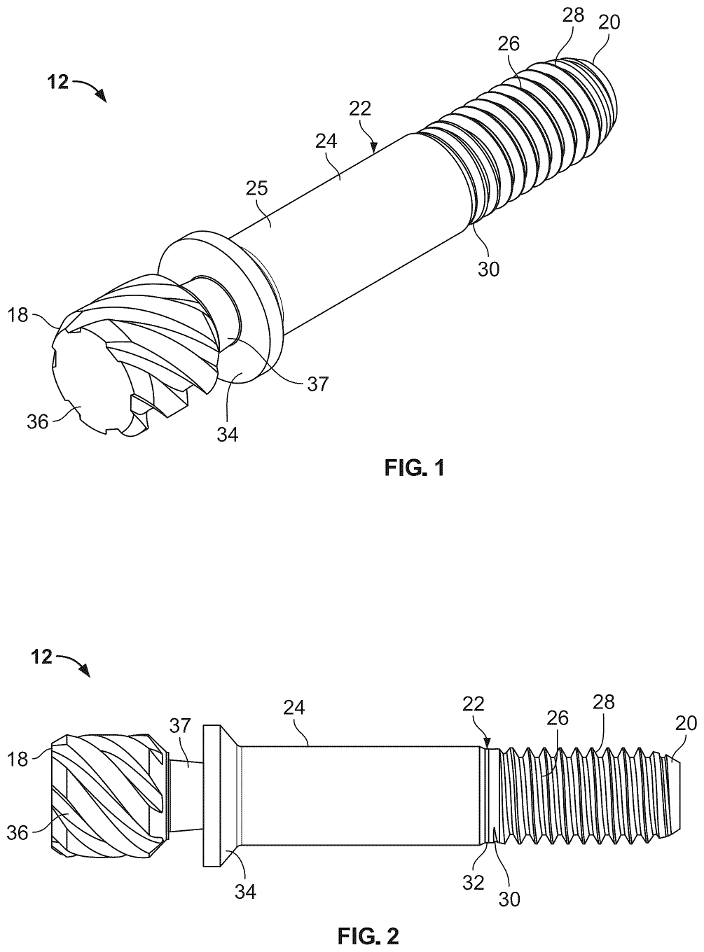

Referring to FIGS. 1 and 2, in some embodiments, the core bolt 12 includes a first end 18, a second end 20 opposite the first end 18, and a shank portion 22 between the first end 18 and the second end 20. In some embodiments, the shank portion 22 includes a cylindrical portion 24 that includes an external surface 25. In some embodiments, the cylindrical portion 24 is proximate to the first end 18. In some embodiments, the shank portion 22 is a smooth cylindrical shank portion. In some embodiments, the shank portion 22 has a first diameter. In some embodiments, the shank portion 22 includes a threaded portion 26. In some embodiments, the threaded portion 26 is proximate to the second end 20. In some embodiments, the threaded portion 26 includes an external thread 28.

In some embodiments, the external thread 28 has a major diameter. In some embodiments, the major diameter is less than the first diameter of the shank portion 22. In some embodiments, the core bolt 12 includes a thread runout 30. In some embodiments, the thread runout 30 is located between the cylindrical portion 24 and the threaded portion 26. In some embodiments, the core bolt 12 is configured to be disposed within the sleeve 14. In some embodiments, the core bolt 12 includes an annular groove 32. In some embodiments, the annular groove 32 is adjacent to the thread runout 30. In some embodiments, the core bolt 12 includes a first head 34. In some embodiments, the first head 34 is proximate to the first end 18. In some embodiments, the first head 34 is a flush head. In some embodiments, the core bolt 12 includes a second head 36. In some embodiments, the second head 36 is located at the first end 18. In some embodiments, the second head 36 is a splined head. In some embodiments, the second head 36 is configured to be engaged by a fastener installation tool. In some embodiments, the second head 36 is removably attached to the first head 34. In some embodiments, the second head 36 is removably attached to the first head 34 by a breakneck portion 37. In some embodiments, the second head 36 is removed from the fastener 10 at the breakneck portion 37.

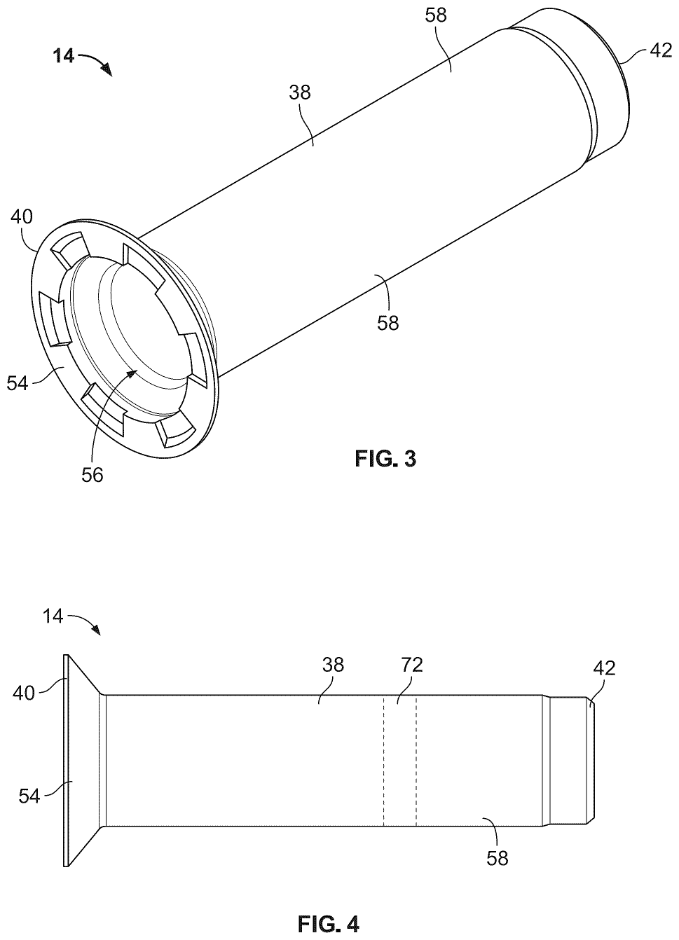

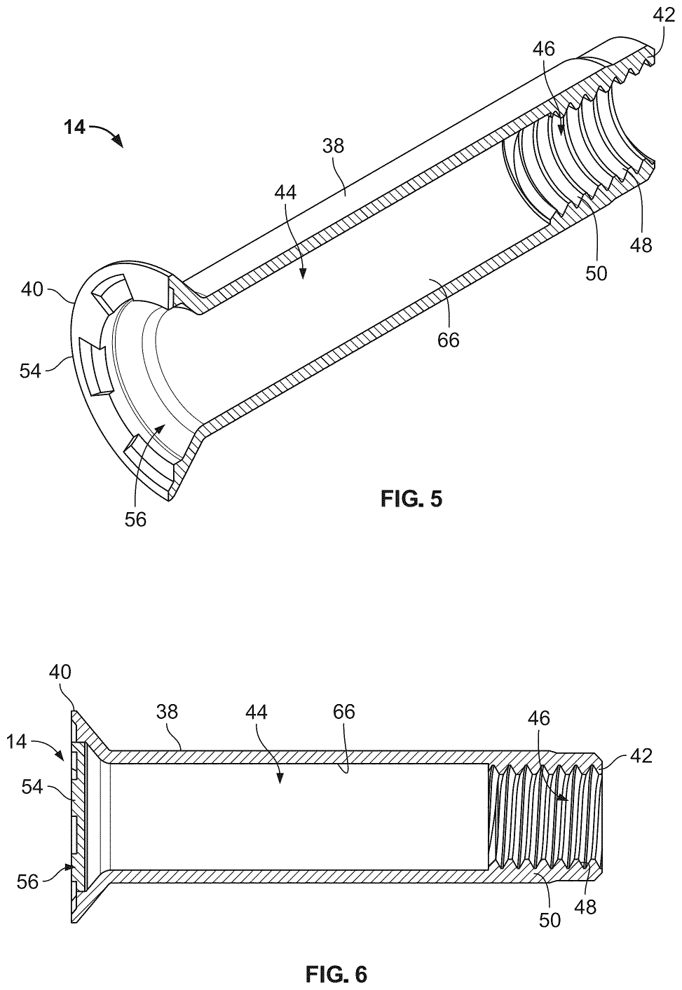

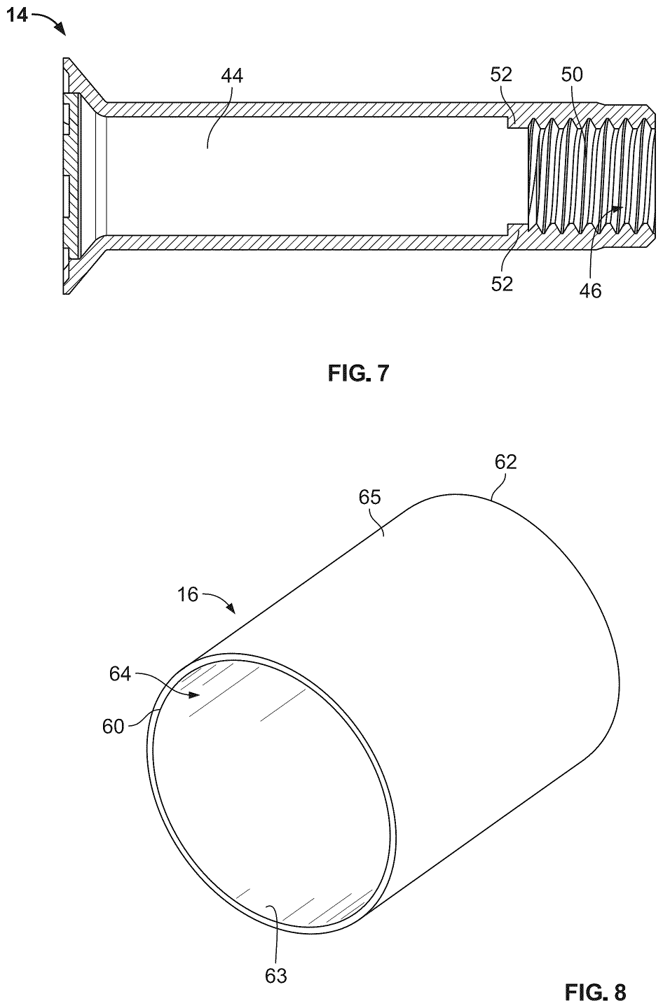

Referring to FIGS. 3 through 6, in some embodiments, the sleeve 14 includes a tubular portion 38. In some embodiments, the tubular portion 38 includes a first end 40, a second end 42 opposite the first end 40, a first portion 44 proximate to the first end 40 and having a first inner diameter, and a second portion 46 proximate to the second end 42. In some embodiments, the sleeve 14 includes an internal surface 66. In some embodiments, the second portion 46 includes an internal thread 48. In some embodiments, the internal thread 48 is located on the internal surface 66 of the second portion 46 of the sleeve 14. Referring to FIG. 7, in some embodiments, the sleeve 14 includes a third portion 50 adjacent the first portion 44. In some embodiments, the third portion 50 includes a second inner diameter that is less than the first inner diameter of the first portion 44. In some embodiments, the sleeve 14 includes an annular step 52. In some embodiments, the annular step 52 is located between the first portion 44 and the third portion 50. In some embodiments, the sleeve 14 does not include the annular step 52.

In some embodiments, the sleeve 14 includes a head 54. In some embodiments, the head 54 is located at the first end 40 of the tubular portion 38. In some embodiments, the head 54 is an enlarged head. In some embodiments, the head 54 includes a pocket 56. In some embodiments, the pocket 56 is sized and shaped to receive the first head 34 of the core bolt 12. In some embodiments, the sleeve 14 includes an external surface 58. In some embodiments, the external surface 58 of the tubular portion 38 of the sleeve 14 includes an outer diameter. In some embodiments, the outer diameter of the external surface 58 is sized and shaped to enable the sleeve 14 to be installed within aligned holes of a plurality of workpieces 110, 112.

Referring to FIG. 8, in some embodiments, the insert 16 includes a first end 60, a second end 62 opposite the first end 60, and an internal surface 63. In some embodiments, the internal surface 63 of the insert 16 forms an aperture 64. In some embodiments, the aperture 64 extends from the first end 60 to the second end 62 of the insert 16. In some embodiments, the insert 16 includes an external surface 65. In some embodiments, the insert 16 has a tubular shape. In some embodiments, the internal surface 63 is cylindrical in shape. In some embodiments, the insert 16 has an internal diameter. In some embodiments, the internal diameter of the insert 16 is larger than the major diameter of the external thread 28 of the core bolt 12. In some embodiments, the insert 16 has an outside diameter. In some embodiments, the outside diameter of the insert 16 is smaller than the smallest internal diameter of the sleeve 14. In some embodiments, the insert 16 is composed of copper. In some embodiments, the insert 16 is composed of Monel® alloy. In some embodiments, the insert 16 is coated. In some embodiments, the insert 16 is coated with a highly electrically conductive coating. In some embodiments, the coating is composed of a conductive metallic material. In some embodiments, the coating is composed of silver. In some embodiments, the coating is composed of gold. In some embodiments, the coating is composed of nickel. In some embodiments, the coating is composed of cadmium. In some embodiments, the coating includes a low coefficient of friction. In some embodiments, the coefficient of friction is less than 0.50.

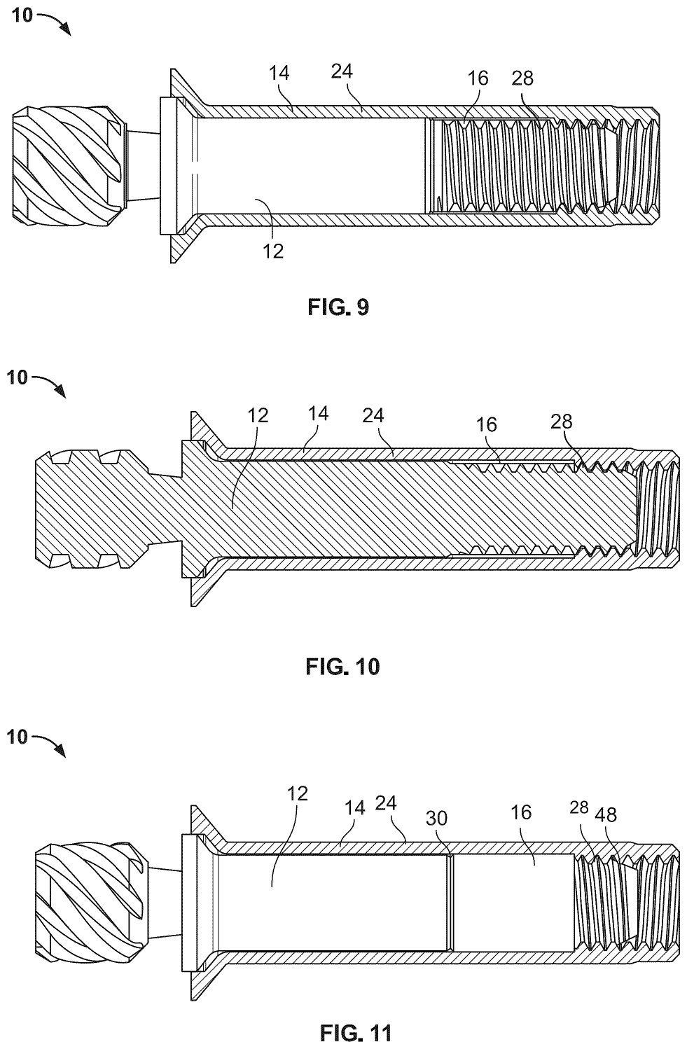

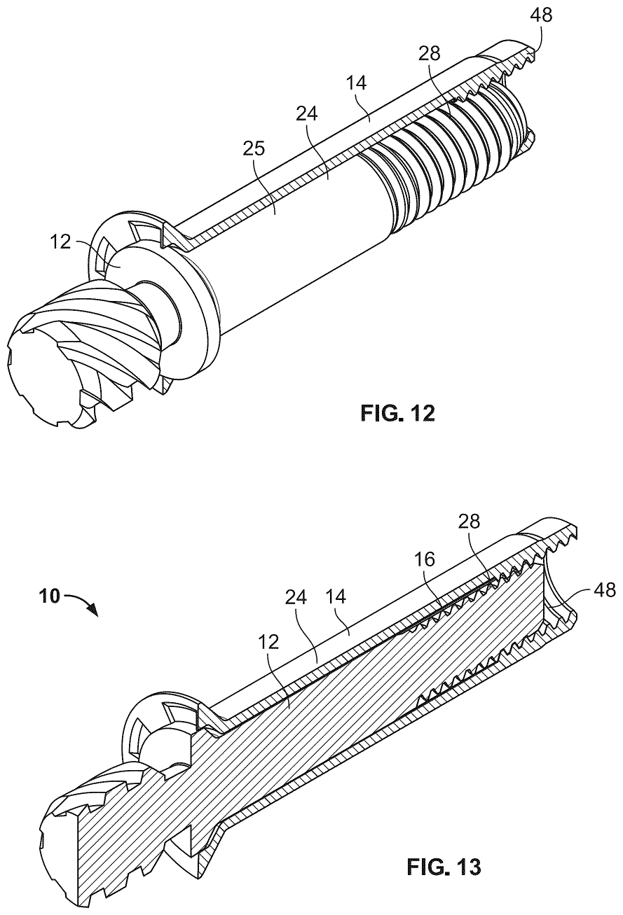

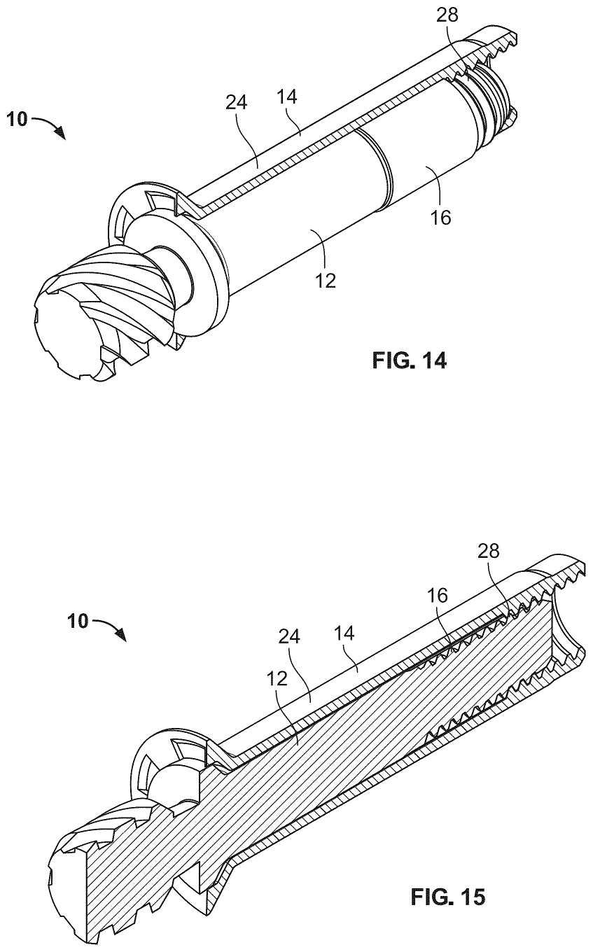

Referring to FIGS. 9 through 15, in some embodiments, the first diameter of the cylindrical portion 24 of the core bolt 12 is sized and shaped to enable the core bolt 12 to be installed within the sleeve 14. In some embodiments, the external thread 28 of the threaded portion 26 of the core bolt 12 is complementary to and configured to threadedly engage the internal thread 48 of the sleeve 14. In some embodiments, the core bolt 12 is configured to be engaged by a fastener installation tool. In some embodiments, the insert 16 is disposed within the sleeve 14. In some embodiments, the insert 16 encircles at least a portion of the threaded portion 26 of the core bolt 12. In some embodiments, the insert 16 encircles the threaded portion 26 of the core bolt 12 in its entirety.

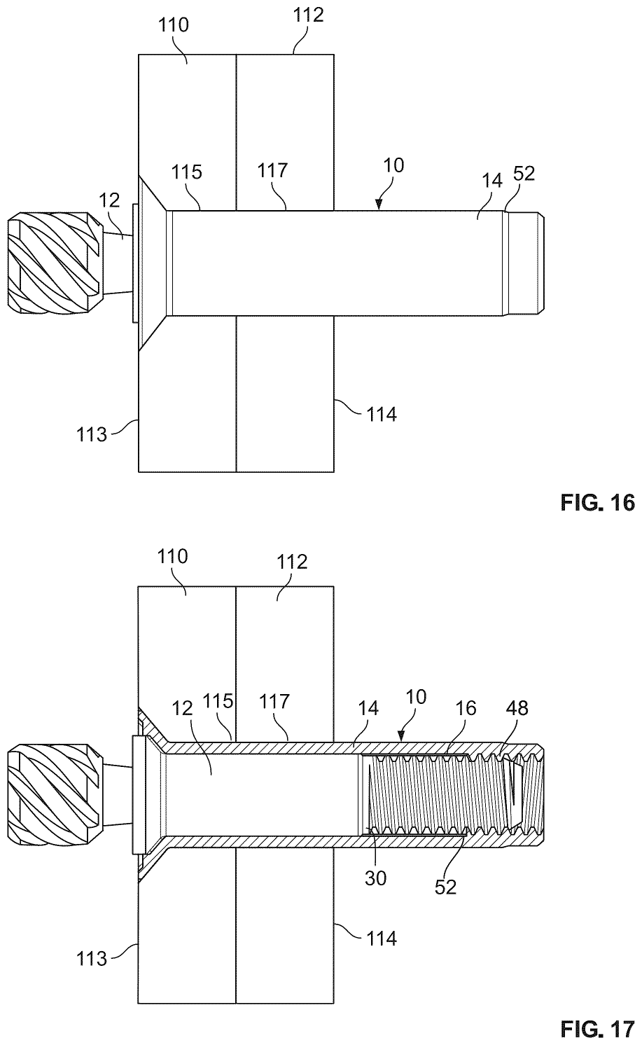

Referring to FIGS. 16 and 17, in some embodiments, the fastener 10 is configured to be installed in aligned holes 115, 117 of the plurality of workpieces 110, 112. In some embodiments, the fastener 10 is assembled and pre-installed within the plurality of workpieces 110, 112. In some embodiments, the workpiece 110 includes an accessible side 113. In some embodiments, the workpiece 112 includes a blind side 114. In some embodiments, the accessible side 113 is opposite the blind side 114. In some embodiments, an installer of the fastener 10 does not have physical or visible access to the blind side 114 thereof. In some embodiments, each of the aligned holes 115, 117 of the workpieces 110, 112 includes an inner diameter. In some embodiments, each of the workpieces 110, 112 is composed of a composite material. In some embodiments, each of the workpieces 110, 112 is composed of a substantially composite material. In some embodiments, the insert 16 is sized and shaped to abut and be retained between the internal thread 48 of the sleeve 14 and the thread runout 30 of the core bolt 12 when the fastener 10 is in a pre-installation position. In some embodiments, the insert 16 is sized and shaped to abut and be retained between the annular step 52 of the sleeve 14 and the thread runout 30 of the core bolt 12 when the fastener 10 is in a pre-installation position.

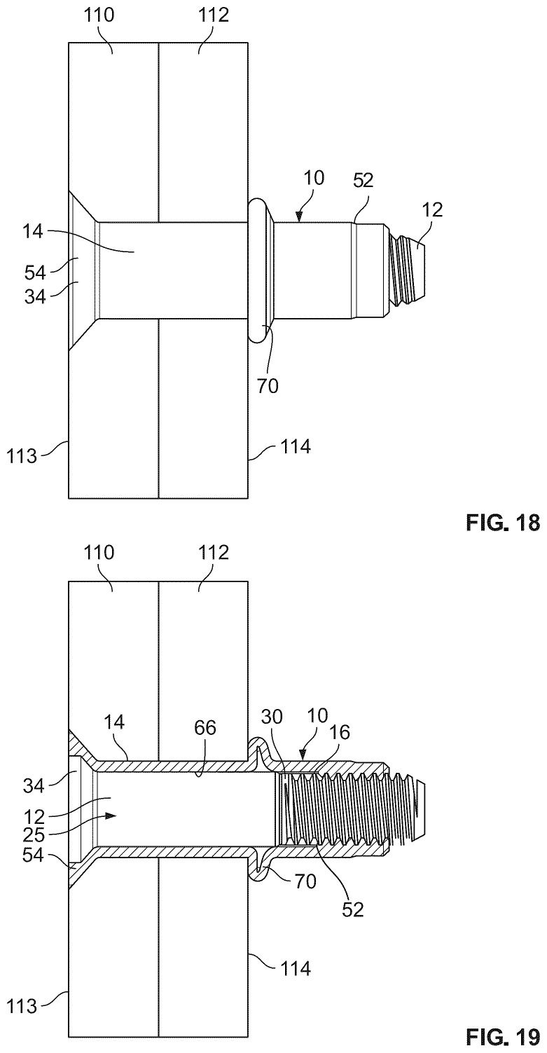

Referring to FIGS. 18 and 19, in some embodiments, during installation of the fastener 10, the insert 16 is compressed between the annular step 52 of the sleeve 14 and the thread runout 30 of the core bolt 12 by an installation motion of the core bolt 12 with respect to the sleeve 14 simultaneously with the installation motion of the core bolt 12. In some embodiments, the length of the insert 16 is configured such that a total volume of the insert 16 is complementary to a total volume of a void located between the internal surface 66 of the sleeve 14 and the external surface 25 of the core bolt 12, so as to fill the void between the core bolt 12 and the sleeve 14 when the fastener 10 is fully installed within the workpieces 110, 112. In some other embodiments, during installation of the fastener 10, the insert 16 is compressed between the internal thread 48 of the sleeve 14 and the thread runout 30 of the core bolt 12 by an installation motion of the core bolt 12 with respect to the sleeve 14 simultaneously with the installation motion of the core bolt 12, which generates a compressive load on the sleeve 14.

In some embodiments, the insert 16 is configured to be compressed between the internal thread 48 of the sleeve 14 and the thread runout 30 of the core bolt 12 by an installation motion of the core bolt 12 with respect to the sleeve 14 simultaneously with a generation of a compressive load on the sleeve 14 by the installation motion of the core bolt 12. In some embodiments, the insert 16 is configured to deform simultaneously with and facilitate a formation of a bulb 70 in the tubular portion 38 of the sleeve 14 in response to compression of the insert 16. In some embodiments, the insert 16 is configured to act as a bearing during the installation process and fill a void between the internal surface 66 of the sleeve 14 and an external surface 25 of the core bolt 12 to form an electrically conductive path between the core bolt 12 and the sleeve 14. In some embodiments, the second head 36 is removed from the fastener 10 at the breakneck portion 37 after the fastener 10 is installed within the workpieces 110, 112. In some embodiments, the first head 34 of the core bolt 12 is flush with the accessible side 113 of the workpiece 110. In some embodiments, the head 54 of the sleeve 14 is flush with the accessible side 113 of the workpiece 110.

In some embodiments, the sleeve 14 is composed of A286 (AISI 660) steel. In some embodiments, the A286 steel is an austenitic precipitation hardening stainless steel. In some embodiments, the sleeve 14 is composed of a 300 series stainless steel. In some embodiments, the sleeve 14 is composed of 304L stainless steel. In some embodiments, the sleeve 14 is composed of 316L stainless steel. In some embodiments, the sleeve 14 is composed of a copper-nickel alloy. In some embodiments, the steel is modified to include a soft layer on the external surface 58 of the sleeve 14. In some embodiments, the term “soft” as defined herein means the layer on the external surface 58 of the sleeve 14 has a hardness of less than Rc 30 on the Hardness Rockwell Scale C.

In some embodiments, the steel is modified to include a hard layer on the internal surface 66 of the sleeve 14. In some embodiments, the term “hard” as defined herein means the layer on the internal surface 66 of the sleeve 14 has a hardness of 8.0 to 8.5 on the Mohs scale. In some embodiments, the sleeve 14 includes a band annealed portion 72. In some embodiments, a first layer on the external surface 58 of the sleeve 14 includes a first hardness. In some embodiments, a second layer on the internal surface 66 of the sleeve 14 includes a second hardness. In some embodiments, the second hardness of the internal surface 66 of the sleeve 14 is greater than the first hardness of the external surface 58 of the sleeve 14. In some embodiments, the band annealed portion 72 is proximate to the insert 16. In some embodiments, the sleeve 14 includes a selectively soft conformal external surface, a selectively hard inner surface, and an annealed portion between the first end 40 and the second end 42 proximate to the insert 16. In some embodiments, the band annealed portion 72 is band annealed by laser or radio frequency induction coil. In some embodiments, the band annealed portion 72 facilitates the formation of the bulb 70 against the surface of the blind side 114 of the workpiece 112 in all grip ranges of the fastener 10.

In some embodiments, the external surface 58 of the sleeve 14 is coated with a soft, highly conductive coating. In some embodiments, the coating has sufficient electrical conductivity. In some embodiments, the coating is galvanically compatible with the sleeve 14. In some embodiments, the coating is galvanically compatible with the workpieces 110, 112. In some embodiments, the coating conforms with an inherent micro-texture of each of the inner surfaces formed by the respective holes in the workpieces 110, 112. In some embodiments, the coating is composed of a metal-based coating. In some embodiments, the coating is composed of silver. In some embodiments, the coating is composed of gold. In some embodiments, the coating is composed of nickel. In some embodiments, the coating is composed of cadmium. In some embodiments, the coating is composed of copper. In some embodiments, the coating is composed of lead. In some embodiments, the coating is composed of an alloy. In some embodiments, the coating is composed of bronze.

In some embodiments, the external surface 58 of the sleeve is not coated. In some embodiments, the external surface 58 of the sleeve 14 is micro-textured. In some embodiments, the micro-texture of the external surface 58 of the sleeve 14 complements the micro-texture inherent to the inner surface forming the hole of each of the workpieces 110, 112. In some embodiments, the micro-texture is 25 micro inch to 40 micro inch.

In some embodiments, the internal surface 66 of the sleeve 14 includes a layer with a higher surface hardness as compared with a hardness of the internal surface 66 being untreated. In some embodiments, the internal surface 66 of the sleeve 14 has a surface hardness of 8.0 to 8.5 on the Mohs scale. In some embodiments, a first friction coefficient between the internal surface 66 of the sleeve 14 and the external surface 25 of the core bolt 12, and a second friction coefficient between the internal surface 66 of the sleeve 14 and the external surface 65 of the insert 16 is selected to facilitate sliding contact between the sleeve 14 and the core bolt 12 and the insert 16 during installation of the fastener 10. In some embodiments, the first friction coefficient is less than 0.5. In some embodiments, the second friction coefficient is less than 0.5. In some embodiments, the friction at the interface between the internal surface 66 of the sleeve 14 and the external surface 25 of the core bolt 12, and the friction at the interface between the internal surface 66 of the sleeve 14 and the external surface 65 of the insert 16, are reduced by the presence of an oxide layer. In some embodiments, the oxide layer includes a high hardness. In some embodiments, the oxide layer has a hardness of 8.0 to 8.5 on the Mohs scale. In some embodiments, the internal surface 66 of the sleeve 14 includes a dual layer. In some embodiments, the dual layer of the internal surface 66 of the sleeve 14 comprises nitrogen and carbon in a first layer and carbon in a second layer. In some embodiments, the first layer of the internal surface 66 of the sleeve 14 is an innermost layer. In some embodiments, the first layer of the internal surface 66 of the sleeve 14 is an outermost layer. In some embodiments, the second layer of the internal surface 66 of the sleeve 14 is an innermost layer. In some embodiments, the second layer of the internal surface 66 of the sleeve 14 is an outermost layer. In some embodiments, as compared with the internal surface 66 of the sleeve 14 being untreated, the microhardness of the internal surface 66 of the sleeve 14 having the dual layer is increased by a factor of two to three. In some embodiments, the microhardness of the internal surface 66 of the sleeve 14 is 8.0 to 8.5 on the Mohs scale.

In some embodiments, a thick, hard oxide layer is selectively grown on the internal surface 66 of the sleeve 14. In some embodiments, the selectively grown thicker oxide layer on the inner surface of the sleeve 14 produces sufficient protection against surface damage and results in lower friction. In some embodiments, a thick, oxide layer is formed slowly at an elevated temperature. In some embodiments, the oxide layer grows up to several microns thick to provide a hard layer. In some embodiments, the hard layer separates the metallic counterparts of the core bolt 12 and the insert 16 from those of the sleeve 14 during the sliding action of the core bolt 12 and the insert 16 relative to the sleeve 14, thus avoiding surface damage and galling and high friction. In some embodiments, the hard layer has a corundum like fine grain structure resulting in a hard surface up to 9.0 on the Mohs scale on the external surface 58 of the sleeve 14.

It should be understood that the embodiments described herein are merely exemplary in nature and that a person skilled in the art may make many variations and modifications thereto without departing from the scope of the present invention. All such variations and modifications, including those discussed above, are intended to be included within the scope of the invention.

What is claimed is:

1. A fastener, comprising:
a sleeve including
a first end and a second end opposite the first end;
a tubular portion including
an external surface,
an internal surface, and
an internal thread formed within the internal surface at the second end; and
a core bolt including
a first end and a second end opposite the first end of the core bolt,
an external surface,
a cylindrical portion proximate to the first end of the core bolt,
an external threaded portion proximate to the second end of the core bolt, and
a thread runout between the cylindrical portion and the external threaded portion,
wherein the core bolt is configured to be disposed within the sleeve, and
wherein the external threaded portion is configured to threadedly engage the internal thread of the sleeve; and
an insert configured to be disposed within the sleeve and encircle a portion of the core bolt proximate to the second end thereof,
wherein the insert is sized and shaped to abut and be retained between the internal thread of the sleeve and the thread runout of the core bolt when the fastener is in a pre-installation position,
wherein the insert is configured to be compressed between the internal thread of the sleeve and the thread runout of the core bolt by an installation motion of the core bolt with respect to the sleeve with a generation of a compressive load on the sleeve by the installation motion of the core bolt,
wherein the insert is configured to deform and facilitate a formation of a bulb in the sleeve in response to compression of the insert,
wherein the insert is configured to fill a void at an area between the external surface of the core bolt proximate to the second end thereof and the sleeve proximate to the second end of the tubular portion of the sleeve, and
wherein the insert is configured to provide an electrically conductive path between the sleeve and the core bolt at the area.

2. The fastener of claim 1, wherein the sleeve is composed of steel.

3. The fastener of claim 2, wherein a first friction coefficient between the internal surface of the sleeve and the external surface of the core bolt and a second friction coefficient between the internal surface of the sleeve and the external surface of the insert are selected to facilitate sliding contact between the sleeve and the core bolt and between the sleeve and the insert during installation of the fastener.

4. The fastener of claim 3, wherein the sleeve includes a first layer on the external surface of the sleeve, wherein the first layer includes a first hardness, and a second layer on the internal surface of the sleeve, wherein the second layer includes a second hardness, and wherein the second hardness is greater than the first hardness.

5. The fastener of claim 4, wherein the first layer is a coating.

6. The fastener of claim 5, wherein the coating is composed of a metal-based coating.

7. The fastener of claim 5, wherein the coating is selected from the group consisting of silver, gold, nickel, cadmium, copper, and lead, or alloys thereof.

8. The fastener of claim 5, wherein the coating is composed of bronze.

9. The fastener of claim 8, wherein the sleeve includes a third layer over the second layer.

10. The fastener of claim 9, wherein the second layer is composed of carbon and the third layer is composed of nitrogen and carbon.

11. The fastener of claim 1, wherein the insert is composed of copper.

12. The fastener of claim 1, wherein the insert is composed of a Monel alloy.

13. The fastener of claim 1, wherein the insert includes a coating.

14. The fastener of claim 13, wherein the coating is selected from the group consisting of silver, gold and nickel.

15. The fastener of claim 3, wherein said sleeve includes a band annealed portion proximate to the insert.

16. The fastener of claim 1, wherein said core bolt includes a head at the first end thereof, wherein the sleeve includes a head at the first end thereof, and wherein the head of the sleeve includes a pocket sized and shaped to receive the head of the core bolt.

17. The fastener of claim 16, wherein the head of the sleeve is configured to be installed in an accessible hole in a plurality of workpieces, and wherein the bulb is configured to be located on a blind side of the workpieces.

18. A fastener, comprising:
a sleeve including
a first end and a second end opposite the first end,
an internal surface,
a tubular portion having,
a head located at the first end,
a first portion proximate to the first end and having a first inner diameter,
a second portion adjacent the first portion and having a second inner diameter that is less than the first inner diameter of the first portion,
a third portion proximate to the second end and having an internal thread in the internal surface, and
a step located between the first portion and the second portion;
a core bolt including
a first end and a second end opposite the first end of the core bolt,
an external surface,
a cylindrical portion proximate to the first end of the core bolt,
an external threaded portion proximate to the second end of the core bolt, and
a thread runout between the cylindrical portion and the external threaded portion,
wherein the core bolt is configured to be disposed within the sleeve, and
wherein the external threaded portion is configured to threadedly engage the internal thread of the sleeve; and
an insert configured to be disposed within the sleeve and encircle a portion of the core bolt proximate to the second end thereof,
wherein the insert is sized and shaped to abut and be retained between the step of the sleeve and the thread runout of the core bolt when the fastener is in a pre-installation position,
wherein the insert is configured to be compressed between the internal thread of the sleeve and the thread runout of the core bolt by an installation motion of the core bolt with respect to the sleeve with a generation of a compressive load on the sleeve by the installation motion of the core bolt, and
wherein the insert is configured to deform and facilitate a formation of a bulb in the sleeve in response to compression of the insert,
wherein the insert is configured to fill a void at an area between the external surface of the core bolt proximate to the second end thereof and the internal surface of the sleeve proximate to the second end of the tubular portion of the sleeve, and
wherein the insert is configured to provide an electrically conductive path between the sleeve and the core bolt at the area.

19. The fastener of claim 18, wherein a first friction coefficient between the internal surface of the sleeve and the external surface of the core bolt and a second friction coefficient between the internal surface of the sleeve and the external surface of the insert are selected to facilitate sliding contact between the sleeve and the core bolt and between the sleeve and the insert during installation of the fastener.

20. The fastener of claim 19, wherein the sleeve includes a first layer on the external surface of the sleeve, wherein the first layer includes a first hardness, and a second layer on the internal surface of the sleeve, wherein the second layer includes a second hardness, and wherein the second hardness is greater than the first hardness.
